(19) United States
(12) Patent Application Publication
(10) Pub. No.: US 2012/0166937 A1
(43) Pub. Date: Jun. 28, 2012

(54) DOCUMENT EDITING APPARATUS, DOCUMENT EDITING METHOD, AND STORAGE MEDIUM

(75) Inventors: Kunihiro Hasegawa, Kawasaki-shi (JP); Kitahiro Kaneda, Yokohama-shi (JP)

(73) Assignee: CANON KABUSHIKI KAISHA, Tokyo (JP)

(21) Appl. No.: 13/326,879

(22) Filed: Dec. 15, 2011

(30) Foreign Application Priority Data
Dec. 28, 2010 (JP) 2010-293020

(51) Int. Cl. G06F 17/00

(52) U.S. Cl. 715/243

(57) ABSTRACT

A document editing apparatus includes an extraction unit, an adjustment unit, and a control unit. The extraction unit is configured to extract a layout variable used for acquiring an evaluation value for a plurality of layout evaluation items used to evaluate a layout of a document, if any layout evaluation item among the plurality of layout evaluation values exists that does not satisfy a layout evaluation reference value. The adjustment unit is configured to adjust a value of the layout variable to satisfy the layout evaluation reference value. The control unit is configured to display the document whose layout has been adjusted by the adjustment unit.

### BACKGROUND OF THE INVENTION

1. Field of the Invention

Embodiments of the present invention relate to a document editing apparatus configured to adjust a state of layout of a character string included in a document.

2. Description of the Related Art

A conventional method optimizes the legibility and appearance of a document by adjusting and evaluating a layout of a character string included in electronic data of a document. As a specific example of a method for executing the adjustment of a layout of a character string, Cascading Style Sheets (CSS) has been used (refer to the following uniform resource locator (URL): http://www.w3.org/Style/CSS/).

In CSS, a font size, a character spacing, etc., may be set to a character string. The font size, character spacing, etc., will be referred to as “layout evaluation items” in the following exemplary embodiments. Japanese Patent No. 4345772 discusses another example of a method for executing the adjustment of a layout of a character string, which automatically changes the font size by using a table that stores a ratio of font sizes among attributes of a document, such as a “title” and “text”.

Japanese Patent Application Laid-Open No. 2005-50351 discusses a specific example of a method for evaluating a layout of a character string. The method discussed in Japanese Patent Application Laid-Open No. 2005-50351 measures a characteristic of a predetermined set, such as the consistency of a style of a document and the easy visibility of a document to design and analyze the layout of a document. Furthermore, the conventional method combines results of the measurement and calculates and quantifies the convenience of the document. In addition, the conventional method generates a measure (a score), which indicates the quality of the document.

However, the method discussed in Japanese Patent Application Laid-Open No. 2005-50351 may evaluate a document layout but may not optimize the layout. Furthermore, in calculating an evaluation result, the conventional method uses a combination function, which combines characteristics together. Accordingly, the method discussed in Japanese Patent Application Laid-Open No. 2005-50351 requires long time and complicated operations necessary for the calculation.

On the other hand, the method discussed in Japanese Patent No. 4345772 may optimize the layout but may adjust only the font size. In other words, the conventional method may not change other layout evaluation values, such as character spacing.

A plurality of layout evaluation values may be changed by utilizing the CSS or by a manual operation. If the CSS is utilized or a manual operation is executed to change a plurality of layout evaluation values, it is not automatically determined whether a change of any specific layout evaluation value may influence on any other layout evaluation values. To paraphrase this, a change of a specific layout evaluation value may degrade other layout evaluation values.

More specifically, if the font size has been adjusted, the length of one line, which is one of the other layout evaluation values, may be influenced and degrade. Similarly, if a plurality of layout evaluation values, such as the length of one line and the font size, is to be adjusted at the same time, the change of one layout evaluation value may cause the degradation of other layout evaluation values. Accordingly, in this case, the layout may not be appropriately set.

In order to solve the above-described problem, a method for changing the layout by preventing an influence on a layout evaluation value by analyzing an influence correlation among a plurality of layout evaluation values may seem useful. However, in this case, it is required to analyze very many layout evaluation items. Accordingly, it may take a lot of time and operations to determine an appropriate method for changing the layout that may not degrade any layout evaluation value.

### SUMMARY OF THE INVENTION

One disclosed aspect of the embodiments is directed to a document editing apparatus capable of generating a text having a high legibility by simultaneously changing a plurality of layout evaluation values related to the text without degrading any layout evaluation value by adjusting a layout variable included in a layout evaluation item. In addition, one disclosed aspect of the embodiments is directed to a document editing apparatus having the above-described configuration and which is capable of reducing the load of analysis of a cross-influence correlation among a plurality of layout evaluation values and the load of a calculation executed to change a layout.

According to an aspect of the embodiments, a document editing apparatus includes an extraction unit, an adjustment unit, and a control unit. The extraction unit is configured to extract a layout variable used for acquiring an evaluation value for a plurality of layout evaluation items used to evaluate a layout of a document, if any layout evaluation item among the plurality of layout evaluation values exists that does not satisfy a layout evaluation reference value. The adjustment unit is configured to adjust a value of the layout variable to satisfy the layout evaluation reference value. The control unit is configured to display the document whose layout has been adjusted by the layout variable value adjustment unit.

According to another aspect of the embodiments, a document editing method includes extracting a layout variable used for acquiring an evaluation value for a plurality of layout evaluation items used to evaluate a layout of a document, if any layout evaluation item among the plurality of layout evaluation values exists that does not satisfy a layout evaluation reference value, adjusting a value of the layout variable to satisfy the layout evaluation reference value, and displaying the document whose layout has been adjusted by adjusting the value of the layout variable.

Further features and aspects of the embodiments will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of embodiments and, together with the description, serve to explain the principles of the embodiments. One disclosed feature of the embodiments may be described as a process which is usually depicted as a flowchart, a flow diagram, a timing diagram, a structure diagram, or a block diagram. Although a flowchart or a timing diagram may describe the operations or events as a sequential process, the operations may be performed, or the events may occur, in parallel or concurrently. In addition, the order of the operations or events may be re-arranged. A process is terminated when its operations are completed. A process may correspond to a method, a program, a procedure, a method of manufacturing or fabrication, a sequence of operations performed by an apparatus, a machine, or a logic circuit, etc.

FIG. 1 illustrates an example of layout optimization processing according to a first exemplary embodiment.

FIG. 2 illustrates an example of processing according to the first exemplary embodiment.

FIG. 3 illustrates an exemplary relationship between a layout evaluation value and a layout variable value used in the first exemplary embodiment.

FIG. 4 is a block diagram illustrating an exemplary hardware configuration of a document editing apparatus according to the first exemplary embodiment.

FIG. 5 is a block diagram illustrating an exemplary functional configuration of the document editing apparatus according to the first exemplary embodiment.

FIG. 6 is a flow chart illustrating an exemplary flow of processing according to the first exemplary embodiment.

FIG. 7 is a flow chart illustrating in detail an exemplary flow of processing for calculating layout evaluation values used in the first exemplary embodiment.

FIG. 8 illustrates an example of a layout evaluation value used in the first exemplary embodiment.

FIG. 9 illustrates a specific example of processing executed by applying a layout evaluation value according to the first exemplary embodiment.

FIG. 10 illustrates a specific example of processing executed by applying a layout evaluation value according to the first exemplary embodiment.

FIG. 11 is a block diagram illustrating an exemplary configuration of a processing method determination unit, which constitutes a layout variable value adjustment unit according to the first exemplary embodiment.

FIG. 12 is a flow chart illustrating an exemplary flow of processing executed by the processing method determination unit constituting the layout variable value adjustment unit according to the first exemplary embodiment.

FIG. 13 illustrates a specific example of processing executed by a layout variable value changing unit according to the first exemplary embodiment.

FIG. 14 illustrates a specific example of processing executed by a common layout variable value changing unit according to the first exemplary embodiment.

FIG. 15 illustrates an exemplary method for determining whether it is appropriate to use the processing method determination unit according to the first exemplary embodiment.

FIG. 16 is a flow chart illustrating in detail an exemplary flow of layout parameter changing processing, which is included in a flow of processing according to the first exemplary embodiment.

FIG. 17 is a flow chart illustrating in detail an exemplary flow of dependent parameter changing processing, which is included in the layout parameter changing processing of a flow of processing according to the first exemplary embodiment.

FIG. 18 is a flow chart illustrating an exemplary flow of processing according to a second exemplary embodiment.

FIG. 19 is a flow chart illustrating in detail an exemplary flow of processing for changing a layout parameter and a coefficient for layout evaluation value calculation expression, which is included in a flow of processing according to a third exemplary embodiment.

FIG. 20 illustrates another exemplary embodiment.

### DESCRIPTION OF THE EMBODIMENTS

Various exemplary embodiments, features, and aspects of the embodiments will be described in detail below with reference to the drawings.

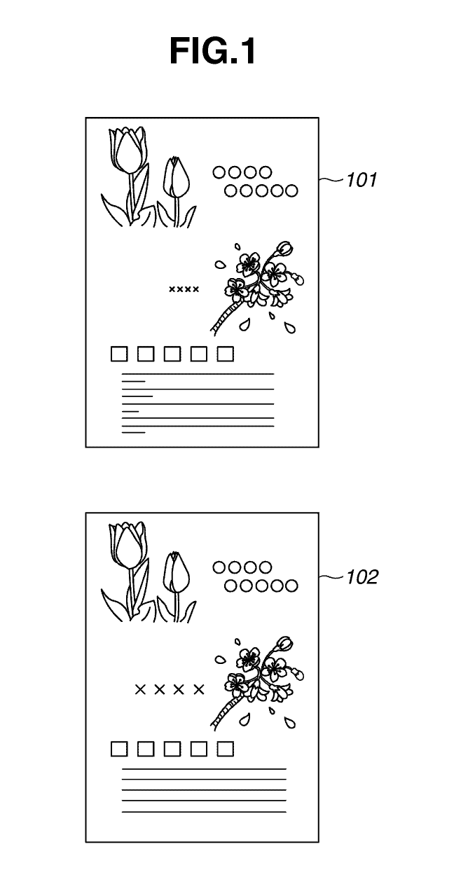

Referring to FIG. 1, a first exemplary embodiment evaluates and optimizes a layout of each text included in an input document 101. In addition, the present exemplary embodiment outputs a document 102, whose text layout has been improved.

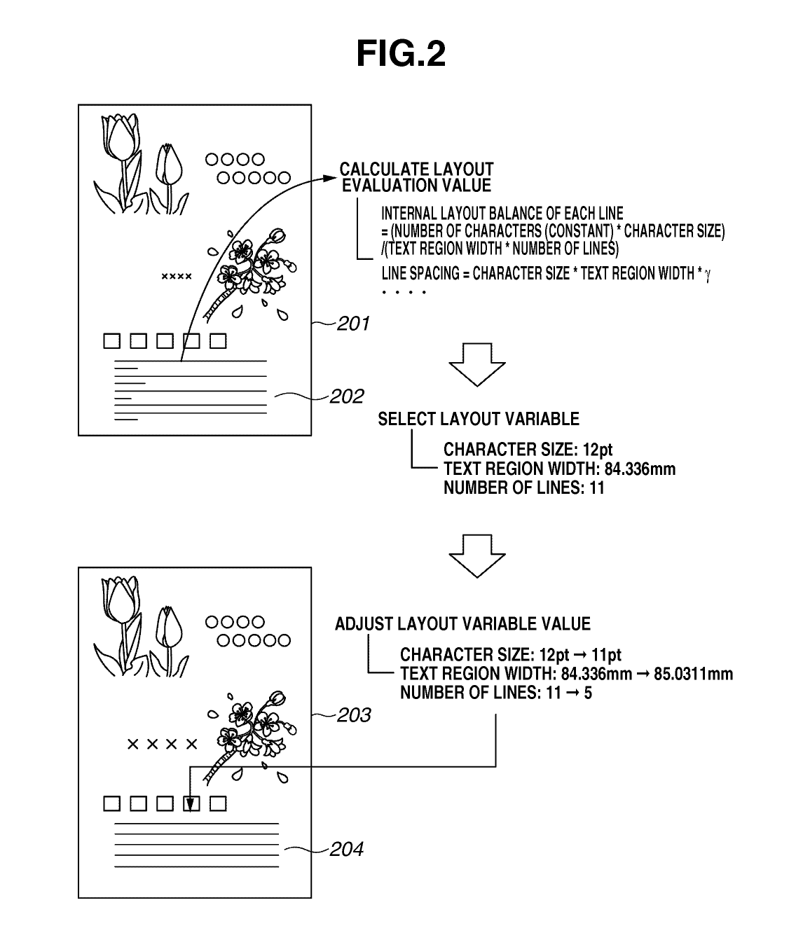

Processing for executing the above-described operations will be described in detail below with reference to FIG. 2. Referring to FIG. 2, a document 201 includes a text 202.

To begin with, the present exemplary embodiment calculates a layout evaluation value for the text 202. In the present exemplary embodiment, a large number of layout evaluation items are used. Among the layout evaluation items, an inner-line layout balance and line spacing will be described in detail first.

A layout evaluation value which describes the inner-line layout balance is defined by the following expression:

Inner-line layout balance=(number of characters(constant)*character size)/(text region width*number of lines).

As described above in the expression, the area of a text region is the denominator and the area of characters in the text region is the numerator.

The closer to 1 the layout evaluation value which describes the inner-line layout balance becomes, the larger the area of characters in the text region is. To paraphrase this, the closer to 1 the layout evaluation value becomes, the less space characters exist and the more balanced the lengths of lines are. A layout evaluation value that describes line spacing is defined by the following expression:

Character size*text region width*coefficient.

Subsequently, the present exemplary embodiment extracts a variable used in at least one of the above-described expressions as a layout variable value. The layout variable value includes three types of values, such as a character size, a text region width, and the number of lines.

In the present exemplary embodiment, a layout variable used for acquiring a plurality of layout evaluation items is referred to as a “common layout variable”. In the text 202, in its original state, the character size is 12 point (pt), the text region width is 84.336 mm, and the number of lines is 9. Subsequently, the layout variable values, i.e., the character size, the text region width, and the number of lines, are changed to 11 pt, 85.039 mm, and 5, respectively, to improve the layout evaluation value.

As a result, a text 204 included in a document 203 is achieved. In the text 204, the lines are well balanced for the lengths compared with the input original text 202. In other words, the layout of the text 204 has been improved compared with the text 202.

Supposing that the texts 202 and 204 are constituted by 106 characters each, the text 202 has an inner-line layout balance value of 0.591 while the text 204 has an inner-line layout balance value of 0.976. In other words, the inner-line layout balance value of the text 204 has greatly improved compared with the inner-line layout balance value of the text 202.

The layout evaluation value may be improved by adjusting the layout variable value because of the following reasons.

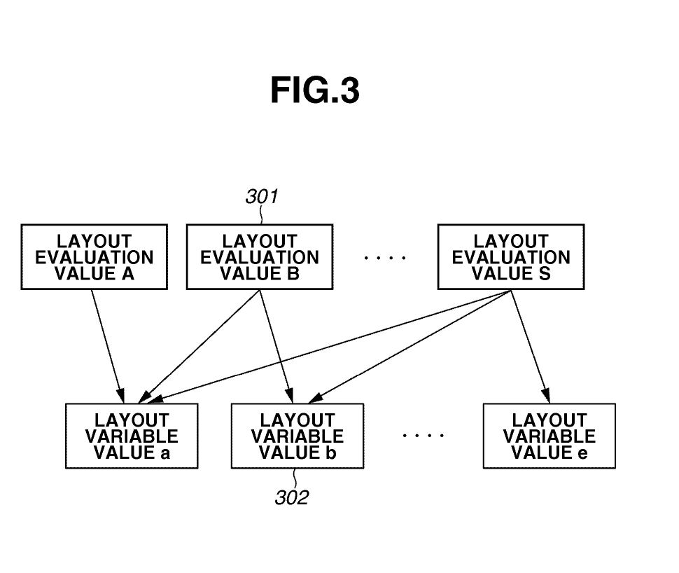

FIG. 3 illustrates an exemplary relationship between the layout evaluation value and the layout variable value. Referring to FIG. 3, each layout evaluation value 301 includes at least one layout variable value 302 in an expression for calculating the layout evaluation value 301. To paraphrase this, the layout evaluation value may be adjusted as a result of adjusting the layout variable value because the layout evaluation value may be adjusted by using a plurality of layout variables.

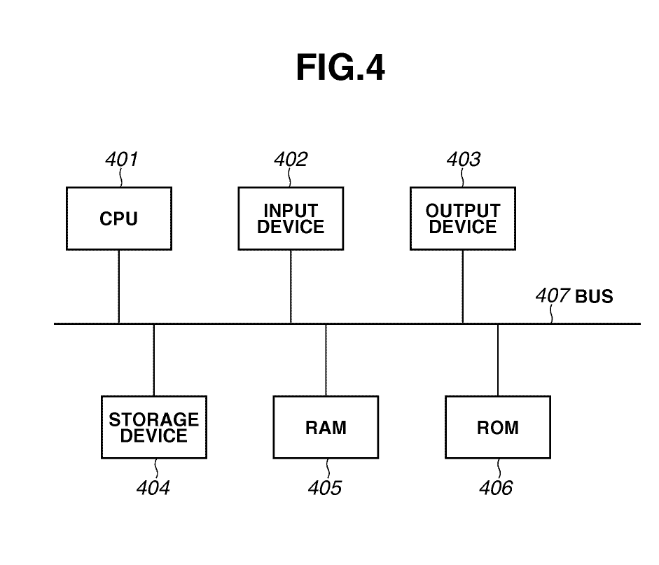

FIG. 4 illustrates an exemplary configuration of a document editing apparatus according to the present exemplary embodiment.

Referring to FIG. 4, the document editing apparatus includes a central processing unit (CPU) 401, an input device 402, an output device 403, a storage device 404, a random access memory (RAM) 405, and a read-only memory (ROM) 406, which are connected to a bus 407. Functions of each of the components 401 through 407 will be described in detail below.

The CPU 401 executes a logical operation and a determination necessary for various types of data processing. In addition, the CPU 401 controls each component connected to the bus 407.

As the input device 402, a keyboard provided with various functional keys is used. The functional keys include an alphabet key, a hiragana character key, katakana character key, a symbol character input key, which is a key for inputting Japanese punctuation characters, and an cursor move key, which is a key for moving a cursor. In addition, a pointing device for pointing at a controllable position on a graphic user interface (GUI) screen to select a function is connected to the input device 402.

Various display devices, such as a liquid crystal panel, may be used as the output device 403. The storage device 404 stores various information, such as input data, data to be output, and a processing program. For a storage medium that stores the above-described data and the program, a hard disk, a compact disc-read only memory (CD-ROM), a digital versatile disc (DVD)-ROM, or a flash memory may be used.

The RAM 405 temporarily stores various data from each component. The ROM 406 stores a control program, such as a processing program executed by the present exemplary embodiment. All the above-described components of the document editing apparatus are connected via the bus 407.

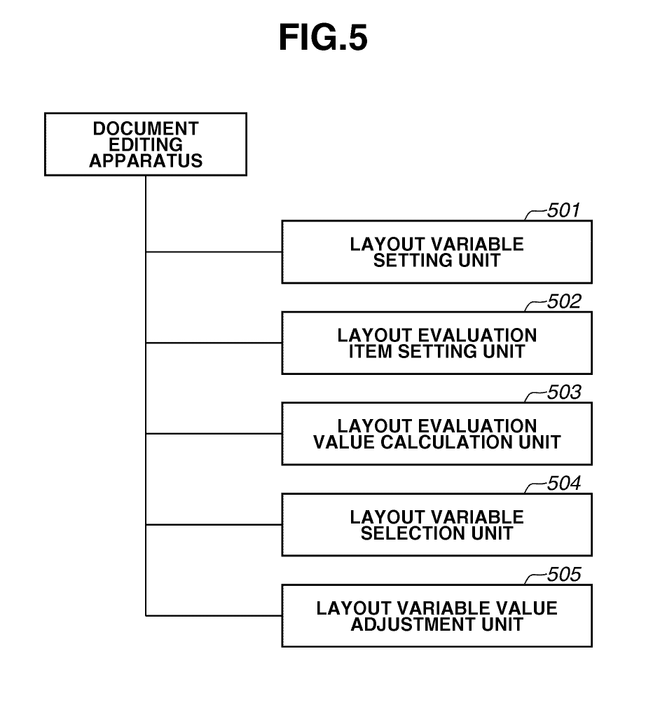

FIG. 5 illustrates an exemplary functional configuration of the document editing apparatus according to the present exemplary embodiment.

Referring to FIG. 5, the document editing apparatus includes a layout variable setting unit 501, a layout evaluation item setting unit 502, a layout evaluation value calculation unit 503, a layout variable selection unit 504, and a layout variable value adjustment unit 505.

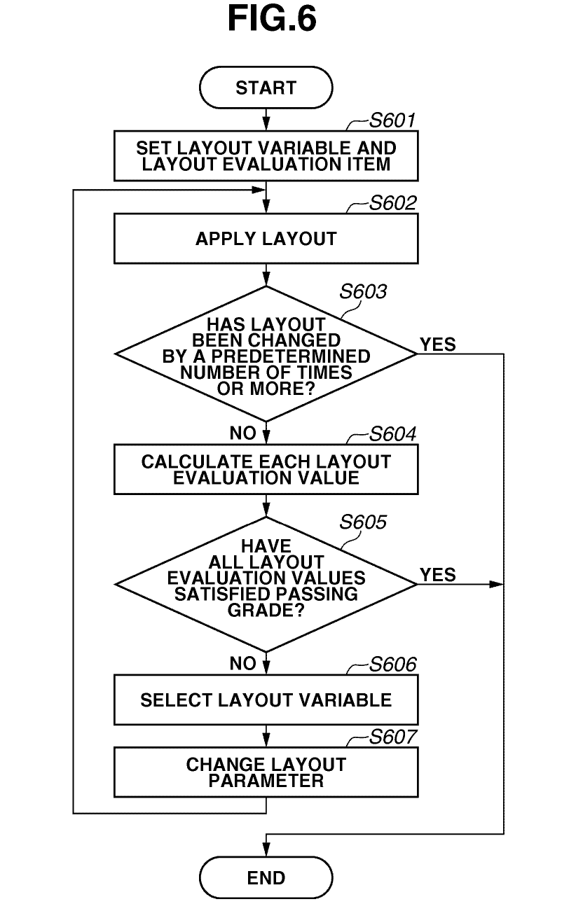

Operations of the components 501 through 505 of the document editing apparatus according to the present exemplary embodiment will be described in detail below with reference to FIG. 6, which illustrates an exemplary flow of the entire processing executed by the present exemplary embodiment.

Referring to FIG. 6, in operation 5601, the layout variable setting unit 501 sets a layout variable to be used in the current processing to the RAM 405. In addition, the layout evaluation item setting unit 502 sets a layout evaluation item to be used in the current processing to the RAM 405.

In operation S602, the document editing apparatus applies a layout of the input document. In operation S603, the document editing apparatus determines the number of times of changes that has been executed on the layout. If the number of times of changes is equal to or greater than a predetermined number of times (YES in operation S603), then the processing ends.

If the number of times of changes is less than the predetermined number of times (NO in operation S603), then the processing advances to operation S604. In operation S604, the layout evaluation value calculation unit 503 calculates each predetermined layout evaluation value.

In operation S605, the document editing apparatus determines whether all the layout evaluation values calculated in operation S604 satisfy a reference value. If it is determined that whether all the layout evaluation values calculated in operation S604 satisfy the reference value (i.e., if all the layout evaluation values are acceptable) (YES in operation S605), then the processing ends. On the other hand, if any value calculated in operation S604 does not satisfy the reference value (i.e., if any layout evaluation value is not acceptable) (NO in operation S605), then the processing advances to operation S606.

In operation S606, the layout variable selection unit 504 selects a layout variable to be changed. An exemplary method for selecting the layout variable to be changed will be described in detail below.

Subsequently, the layout variable selection unit 504 transfers the layout variable value to the layout variable value adjustment unit 505. In operation S607, the layout variable value adjustment unit 505 changes a layout parameter. Then, the document editing apparatus increments the number of times of changes of the layout by 1.

In the present exemplary embodiment, the layout parameter includes components that constitute a layout. The layout parameter includes a layout variable. In addition, a layout evaluation item is included in the layout parameter and is an item used in evaluating the layout.

Then, the processing returns to operation S602 to execute the layout, determine the number of times of changes of the layout, calculate the layout evaluation value, and determine the layout evaluation value in operation S605 by using the changed parameter. The document editing apparatus repeats the above-described processing until it is determined that all the layout evaluation values satisfy the reference value (i.e., until all the layout evaluation values are determined acceptable). The above-described processing is executed by the CPU 401.

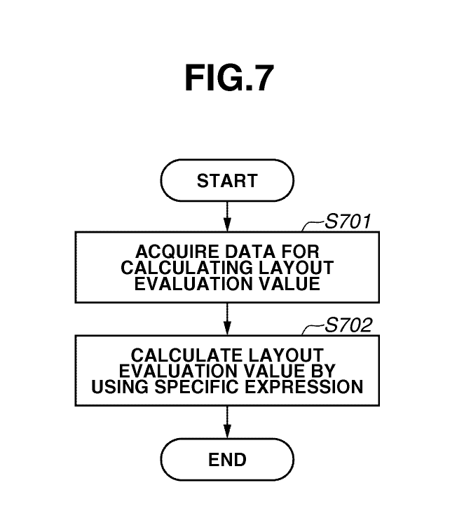

FIG. 7 is a flow chart illustrating in detail an exemplary flow of the processing in operation S604.

Referring to FIG. 7, in operation S701, the document editing apparatus acquires necessary data, such as a layout variable value, the size of the document, and the purpose of use of the text, to calculate the layout evaluation value. More specifically, the document editing apparatus acquires five types of data, such as the purpose of use of the text, the document size, the character size, the text region width, and the number of lines.

The purpose of use of the text describes the attribute (a text or a title) of the text. The document size is the name of paper sizes defined by a publicly known standard, such as A4 or B5, or a specific document size defined by a publicly known standard. Among the above-described necessary data, the purpose of use of the text and the document size are attached to the document as data of a publicly known standard, such as eXtended Markup Language (XML) data. The document editing apparatus acquires the necessary data from the document.

The other necessary data, i.e., the character size, the text region width, and the number of lines may be acquired from those attached to the document as data of a publicly known standard similarly to the case of the purpose of use of the text and the document size. Alternatively, the character size, the text region width, and the number of lines may be acquired from the text itself or from an image of the text by using an appropriate publicly known method. A conventional method discussed in Japanese Patent Application Laid-Open No. 2007-122500 may be used as a method for acquiring the character size.

In operation S702, the document editing apparatus calculates each layout evaluation value based on the acquired data.

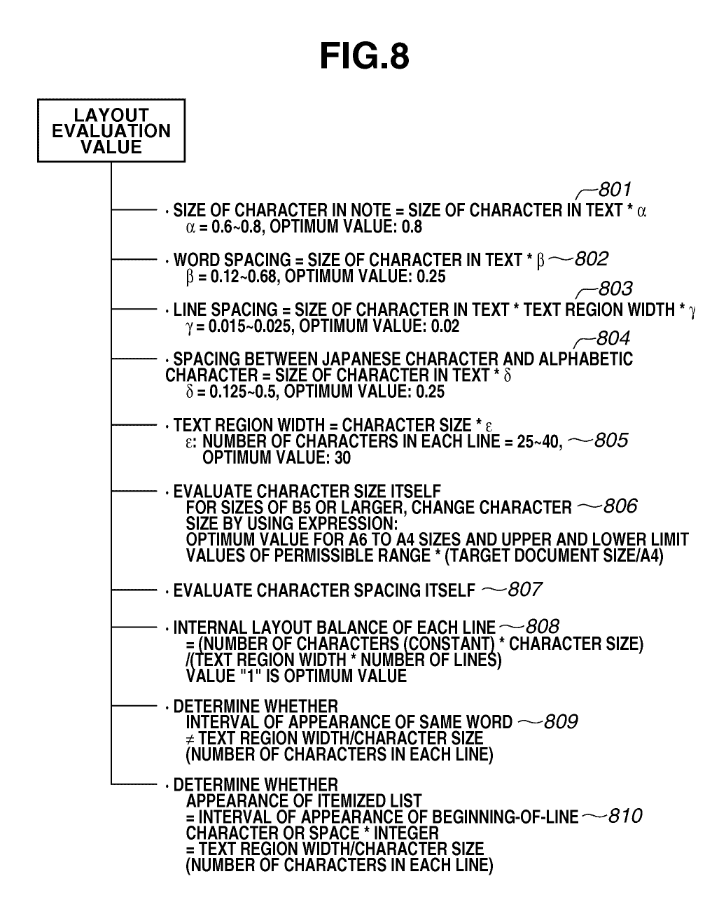

An exemplary configuration of a layout evaluation value, an exemplary layout evaluation value calculation method, and an exemplary processing executed on the layout evaluation value will be described in detail below with reference to FIG. 8.

Layout evaluation values used in the present exemplary embodiment are illustrated in FIG. 8. More specifically, a note character size 801, a word spacing 802, a line spacing 803, a Japanese character-to-alphabetic character spacing 804, a text region width 805, a character size 806, a character spacing 807, an inner-line layout balance 808, a same-word appearance interval 809, and an itemized list appearance 810 are used in the present exemplary embodiment.

Each of the layout evaluation values will be described in detail below. The note character size 801 may be calculated by using the following calculation expression (1):

Size of character in note=size of character in text*α(range of α=0.65-0.8,optimum value:0.7) (1).

The evaluation is executed according to a result of a determination as to whether the calculated note character size is in an appropriate range. The calculation expression (1) is used on the following ground.

Because a note supplements a text, it is required that the character size in a note be smaller than the character size of the text. However, if the size of a character in the note is excessively small, the note may have a low legibility. Accordingly, the note character size should be large enough to be appropriately legible and small enough to be recognized as a supplement to the text.

More specifically, the note character size may become optimum at 0.7 times of the text character size and the permissible range of a note character size may be 0.6 to 0.8 times of the text character size.

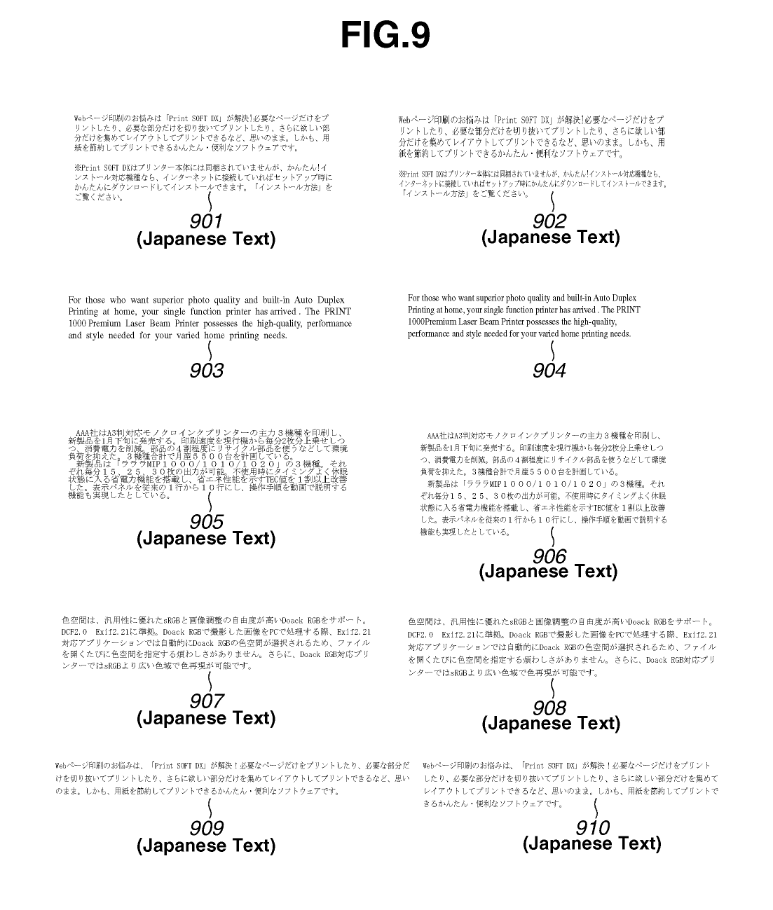

Texts 901 and 902 (FIG. 9) are generated after the layout evaluation value is applied. The layout evaluation value is a specific value that is used as the basis of executing a layout. The note character size of the text 901 is too large. Accordingly, the layout evaluation value of the text 901 is low. On the other hand, the note character size of the text 902 falls within the permissible range. Accordingly, the layout evaluation value of the text 902 is high.

In evaluating the layout, the layout may be evaluated merely by determining the mere appropriateness of the layout according to a result of a determination as to whether the layout evaluation value is within a permissible range. Alternatively, the layout may be evaluated by using continuous values.

If the layout is to be evaluated by using continuous values, the layout is evaluated on a scale of 100 (the optimum value) and is determined acceptable at a predetermined grade of 80 (on the scale of 100) (in this case, the upper limit of the permissible range is 100 and the lower limit of the permissible range is 80). The other portion may be calculated by interpolation by using a linear function, a quadratic function, and an exponential function.

The interpolation may be executed by the following methods. More specifically, the interpolation method may be selected by the user by hand. Alternatively, a plurality of users may evaluate learning samples that gradually include layout evaluation items that differ from one another by one item only and a function that may most appropriately approximate the results of the evaluation may be employed. Further alternatively, the interpolation method may be selected according to the type of a target document (i.e., a poster, a business document, and the like). The evaluation of a layout according to each layout evaluation item may be executed by using the following expressions (2) through (10).

The word spacing 802 may be calculated by using the following calculation expression (2):

word spacing=size of character in text*β (2)

(range of β=0.12-0.67, optimum value: 0.25).

The evaluation is executed according to a result of a determination as to whether the calculated word spacing is in an appropriate range. The calculation expression (2) is used on the following ground.

Word spacing is a space character between words in an alphabetic text. If no word spacing exists between words of a text, the words may not be distinguished from one another. On the other hand, if word spacing is excessively large, the legibility of the text may degrade. Accordingly, it is necessary to place word spacing of an appropriate size between words.

As a result of a close examination, the word spacing became optimum at 0.25 times of the text character size and the permissible range of the word spacing was 0.12 to 0.67 times of the text character size.

Texts 903 and 904 (FIG. 9) are generated after the layout evaluation value is applied. The word spacing of the text 903 is too large. Accordingly, the layout evaluation value of the text 903 is low. On the other hand, the word spacing of the text 904 falls within the permissible range. Accordingly, the layout evaluation value of the text 904 is high.

The line spacing 803 may be calculated by using the following calculation expression (3):

line spacing=size of character in text*text region width*γ (3)

(range of γ=0.015-0.025, optimum value: 0.02).

The evaluation is executed according to a result of a determination as to whether the calculated line spacing is in an appropriate range. The calculation expression (3) is used on the following ground.

Line spacing is a space placed between lines of a text. If the line spacing is too small, the lines are arranged excessively tight. Accordingly, the legibility of the text may become low. On the other hand, if the line spacing is too large, the lines are arranged excessively loose. In this case also, the legibility of the text may become low. Accordingly, it is necessary to place line spacing of an appropriate size.

As a result of a close examination, the line spacing became optimum at 0.02 times of a product of the text character size and the text region width and the permissible range of the line spacing was 0.015 to 0.025 times of the product of the text character size and the text region width.

Texts 905 and 906 (FIG. 9) are generated after the layout evaluation value is applied. The line spacing of the text 905 is too small. Accordingly, the layout evaluation value of the text 905 is low. On the other hand, the line spacing of the text 906 falls within the permissible range. Accordingly, the layout evaluation value of the text 906 is high.

The Japanese character-to-alphabetic character spacing 804 may be calculated by using the following calculation expression (4):

spacing between Japanese character and alphabetic character=size of character in text*δ (4)

(range of δ=0.125-0.5, optimum value: 0.25).

The evaluation is executed according to a result of a determination as to whether the calculated line spacing between a Japanese character and an alphabetic character is in an appropriate range. The calculation expression (4) is used on the following ground.

Spacing between a Japanese character and an alphabetic character is a space character placed between a Japanese character and an alphabetic character. The Japanese character includes a kanji character, a kana character, and the like. The alphabetic character includes alphabets.

Because the characters are differently designed for Japanese characters and the alphabetic characters, it is necessary to place a space larger than the space placed between mutually adjacent Japanese characters or between mutually adjacent alphabetic characters. Otherwise, the legibility of the text may degrade. Accordingly, the spacing is placed between a Japanese character and an alphabetic character.

As a result of a close examination, the spacing between a Japanese character and an alphabetic character became optimum at 0.25 times of the text character size and the permissible range of the spacing between a Japanese character and an alphabetic character was 0.125 to 0.5 times of the spacing between a Japanese character and an alphabetic character.

Texts 907 and 908 (FIG. 9) are generated after the layout evaluation value is applied. The spacing between a Japanese character and an alphabetic character of the text 907 is too small. Accordingly, the layout evaluation value of the text 907 is low. On the other hand, the spacing between a Japanese character and an alphabetic character of the text 908 falls within the permissible range. Accordingly, the layout evaluation value of the text 908 is high.

The text region width 805 may be calculated by using the following calculation expression (5):

Text region width=character size*ε (5)

(range of ε (number of characters in each line)=25-40, optimum value: 40).

The evaluation is executed according to a result of a determination as to whether the calculated text region width is in an appropriate range. The calculation expression (5) is used on the following ground.

The text region width is a width of a text box. The text box width is equivalent to the width of one line of a text. If the width is too narrow or too wide, the speed of reading the text may degrade. Accordingly, the legibility of the text may become low. Accordingly, it is necessary to set an appropriate width.

As a result of a close examination, the text region width, which is a product of the character size and the number of characters in each line, became optimum at 30 characters and the permissible range of the text region width was 24 to 40 characters.

The text region width is used also as the layout variable value. Accordingly, in changing the text region width when the layout variable value is to be changed, the text region width is changed within the permissible range.

Texts 909 and 910 (FIG. 9) are generated after the layout evaluation value is applied. The text region width of the text 909 is too wide. Accordingly, the layout evaluation value of the text 909 is low. On the other hand, the text region width of the text 910 falls within the permissible range. Accordingly, the layout evaluation value of the text 910 is high.

The character size 806 may be calculated by using the following calculation expression (6):

Character size=optimum value for A6 to A4 sizes and upper and lower limit values of a permissible range*(target document size/A4) (6)

(for sizes of B5 or larger).

The evaluation is executed according to a result of a determination as to whether the calculated character size is in an appropriate range. The calculation expression (6) is used on the following ground.

The character size describes the dimension of a character constituting a text. If the character size is too large or too small, the legibility of the text may degrade. Accordingly, it is necessary to set an appropriate character size.

In addition, because the appropriate character size may differ according to the display screen or the purpose of use (the text or the title) of the text, it is necessary to adjust the character size according to the display screen and the purpose of use of the text.

As a result of a close examination, the following was found. In the examination, the optimum value of the character size and the permissible range for an A4 size sheet were used as the reference. For sheets larger than A4 size, a product of the ratio of the sizes (the width or the length) of the target document and A4 (the document was the numerator and A4 was the denominator) and the reference value was used. For the text used for the title, the character size was set at three to five times of the text character size according to the ratio of images in the document. For the reference value, the optimum value for a Japanese character was 10 pt and the permissible range was 8 to 11 pt. The optimum value for an alphabetic character was 10 pt and the permissible range was 10 to 12 pt.

The character size is also used as a layout variable value. Accordingly, in changing the character size during processing for changing layout variable values, the character size is changed within the permissible range.

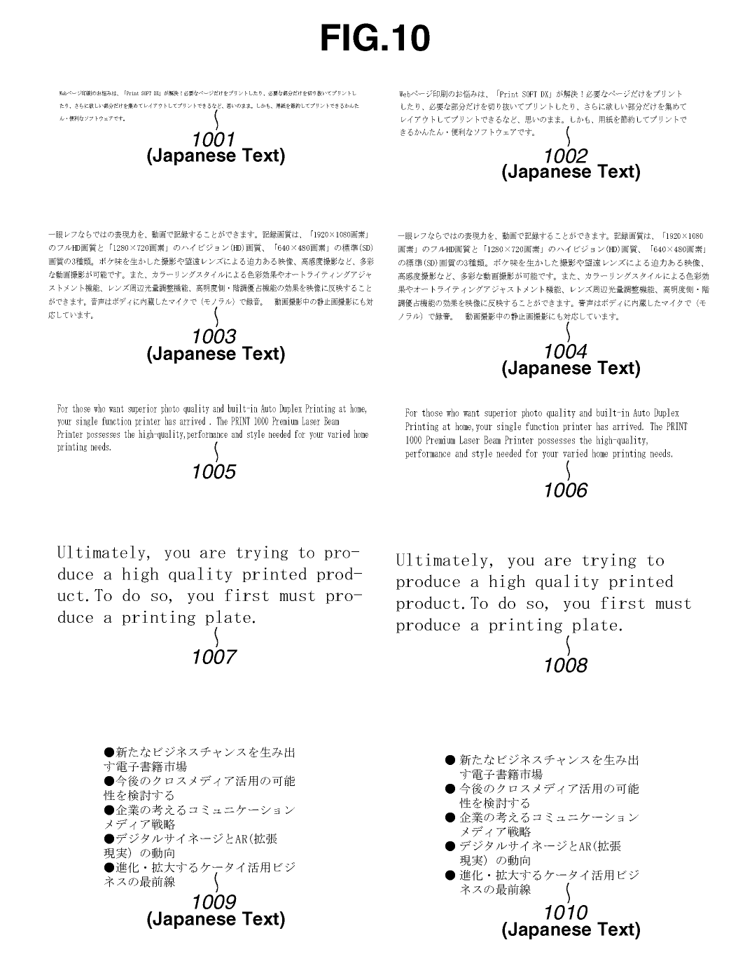

Texts 1001 and 1002 (FIG. 10) are generated after the layout evaluation value is applied. The character size of the text 1001 is too small. Accordingly, the layout evaluation value of the text 1001 is low. On the other hand, the character size of the text 1002 falls within the permissible range. Accordingly, the layout evaluation value of the text 1002 is high.

The character spacing 807 may be calculated by using the following calculation expression (7):

Character spacing=character spacing (7).

In other words, character spacing itself is evaluated.

The evaluation is executed according to a result of a determination as to whether the character spacing is close to the reference value. The calculation expression (7) is used on the following ground.

Character spacing describes an interval between characters constituting the text. If the character spacing is too small, the characters are overlapped one another. On the other hand, if the character spacing is too wide, the intervals between words may become unnatural. The legibility of the text may degrade in these cases. Accordingly, it is necessary to set appropriate character spacing.

A character is designed by surrounding the character itself (the type face) with a space. Accordingly, if the character spacing is not explicitly set, a space may be left between characters. Therefore, the optimum value for the character spacing was “0”.

Texts 1003 and 1004 (FIG. 10) are generated after the layout evaluation value is applied. The character spacing of the text 1003 is too small. Accordingly, the layout evaluation value of the text 1003 is low. On the other hand, the character spacing of the text 1004 falls within the permissible range. Accordingly, the layout evaluation value of the text 1004 is high.

The inner-line layout balance 808 may be calculated by using the following calculation expression (8):

Inner-line layout balance=(number of characters(constant)*character size)/(text region width*number of lines) (8).

The evaluation is executed according to a result of a determination as to whether the calculated internal layout balance of each line is close to “1”. The calculation expression (8) is used on the following ground.

The inner-line layout balance describes whether any line exists whose length is different from the length of the other lines. If the lines are not balanced for the length, a line including very many space characters may exist. In this case, the appearance of the text may degrade. Accordingly, it is necessary to appropriately balance the lengths of the lines.

Similar to the example described above with reference to FIG. 2, the area of a text region is calculated by an expression “text region width*number of lines” and the area of characters in the text region is calculated by an expression “number of characters*character size”. Accordingly, the closer the value of the area of the characters in the text region becomes, the larger the ratio of the characters in the text region becomes. In other words, in this case, the text includes a small number of space characters and the lines of the text are balanced for their lengths.

Texts 1005 and 1006 (FIG. 10) are generated after the layout evaluation value is applied. The level of the inter-line balance of the text 1005 is low. Accordingly, the layout evaluation value of the text 1005 is low. On the other hand, the level of the inter-line balance of the text 1006 falls within the permissible range. Accordingly, the layout evaluation value of 1006 is high.

The same-word appearance interval 809 may be calculated by using the following calculation expression (9):

Interval of appearance of same word≠text region width/character size (9)

(number of characters in each line).

The evaluation is executed according to a result of a determination as to whether the calculation expression (9) holds. The calculation expression (9) is used on the following ground.

The interval of appearance of the same word describes whether the same word appears at the same location continuously across a plurality of lines. If the same word appears at the same location continuously across a plurality of lines, the appearance and the legibility of the text may degrade. Accordingly, it is necessary to prevent the same word from appearing at the same location continuously across a plurality of lines.

If the same word appears at the same location continuously across a plurality of lines, the number of characters or the length of the character string existing between the same words is equivalent to the number of characters in one line or the length of one line. Accordingly, the evaluation may be executed according to a result of a determination as to whether the calculation expression (9) holds.

Texts 1007 and 1008 (FIG. 10) are generated after the layout evaluation value is applied. In the text 1007, hyphens consecutively appear at the end of a plurality of lines. Accordingly, the layout evaluation value of the text 1007 is low. On the other hand, the same characters, such as hyphens, do not appear on consecutive lines in the text 1008. Accordingly, the layout evaluation value of the text 1008 is high.

The itemized list appearance 810 may be calculated by using the following calculation expression (10):

$$\begin{matrix}\begin{matrix}Appearance of itemized list = interval of appearance of \\ beginning \text{-} of \text{-} line \\ character or space * integar \\ = \frac{text region width}{character size}\end{matrix} & ( 10 ) \\ ( number of characters in each line ) . & \end{matrix}$$

The evaluation is executed according to a result of a determination as to whether the calculation expression (10) holds. The calculation expression (10) is used on the following ground.

The appearance of an itemized list describes whether the appearance of a plurality of lines in which the text begins after a specific symbol (the beginning-of-line character) exist, which is recognized as an itemized list, is appropriately legible.

In the exemplary itemized list (the texts 1009 and 1010), a space character is placed after a beginning-of-line character and the text begins after the space character. If one item continues across two lines, the second line begins immediately below a location at which the text of the first line begins. Unless the above-described appearance is achieved, the appearance and the legibility may degrade or the text may not be appropriately recognized as an itemized list. Accordingly, it is necessary to satisfy the condition for the appearance of an itemized list.

The determination may be executed according to a result of a determination as to whether the beginning-of-line characters and the space characters appear at the same location of the plurality of lines. Accordingly, the determination may be executed by the determination method reverse to the method for determining the same-word appearance interval.

Texts 1009 and 1010 (FIG. 10) are generated after the layout evaluation value is applied. In the text 1009, the text does not have an appropriate appearance of an itemized list. Accordingly, the layout evaluation value of the text 1009 is low. On the other hand, the text 1010 has an appropriate appearance of an itemized list. Accordingly, the layout evaluation value of the text 1010 is high.

In operation S605 (FIG. 6), it is determined whether each layout evaluation value calculated in the above-described manner satisfies the reference value. If it is determined that any layout evaluation value does not satisfy the reference value (NO in operation S605), then the processing advances to operation S606. In operation S606, the layout variable is selected. In operation S607, the selected layout variable value is changed. Then the layout is changed to change all the layout evaluation values to satisfy the reference value.

In executing the above-described change, in the first stage of the change, the optimum value set to each variable is used. Then, the change is executed at random within the permissible range set to each variable.

The layout of a document may be evaluated according to the ratio of the number of acceptable layout evaluation items to the number of layout evaluation items or by using an average of the layout evaluation values for layout evaluation items in addition to whether any layout evaluation value exists that does not satisfy the reference value.

Furthermore, each layout evaluation item may be weighted. As an exemplary method for the weighting, the weighting method may be selected by the user by hand. Alternatively, a plurality of users may evaluate learning samples that gradually include layout evaluation items that differ from one another by one item only and a function that may most appropriately approximate the results of the evaluation may be employed. Further alternatively, the weighting method may be selected according to the type of a target document (i.e., a poster, a business document, and the like).

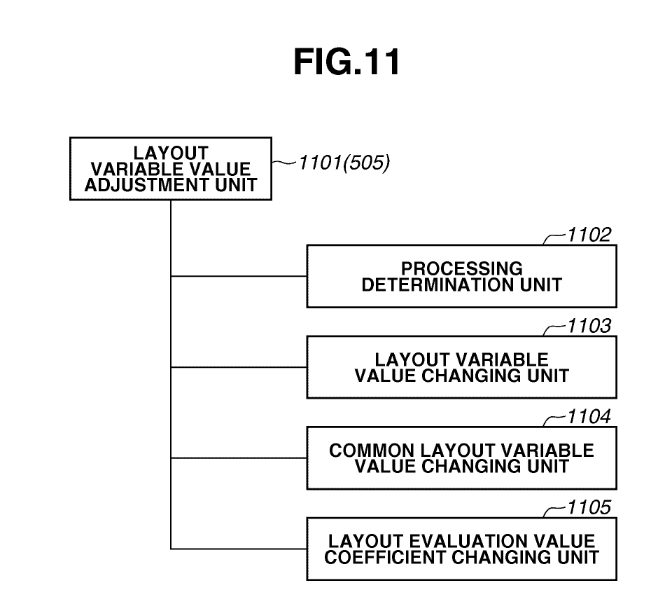

In operation S606, all the layout variables or a part of layout variables may be selected. A layout variable value adjustment unit 1101 (FIG. 11) (equivalent to the layout variable value adjustment unit 505) selects the layout variable. In the present exemplary embodiment, the layout variable value adjustment unit 1101 selects one layout variable.

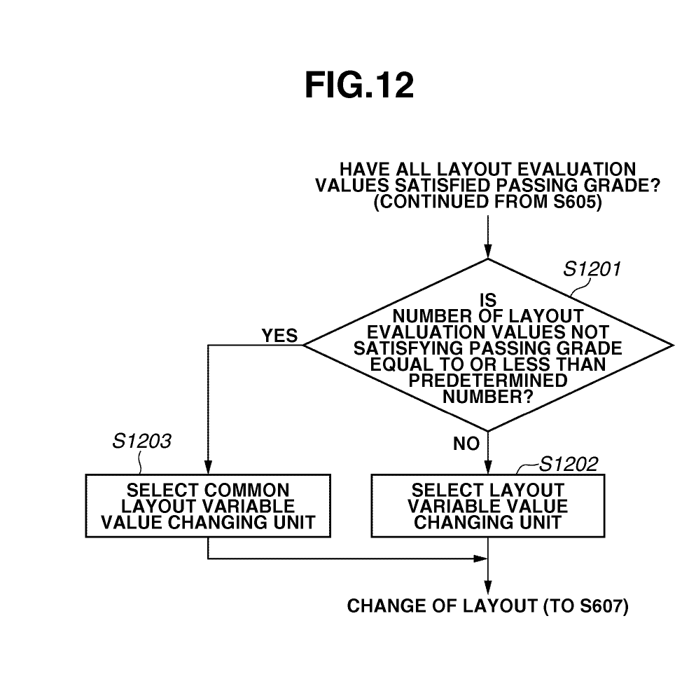

In the present exemplary embodiment, as illustrated in FIG. 12, in operation S1201, a processing determination unit 1102 selects a processing unit according to the number of non-acceptable layout evaluation values.

If the number of non-acceptable layout evaluation values is more than a predetermined number (i.e., if a relatively large number of non-acceptable layout evaluation values exists) (NO in operation S1201), then the processing advances to operation S1202. In operation S1202, a layout variable value changing unit 1103 changes all the layout variable values to improve a large number of layout evaluation values at the same time.

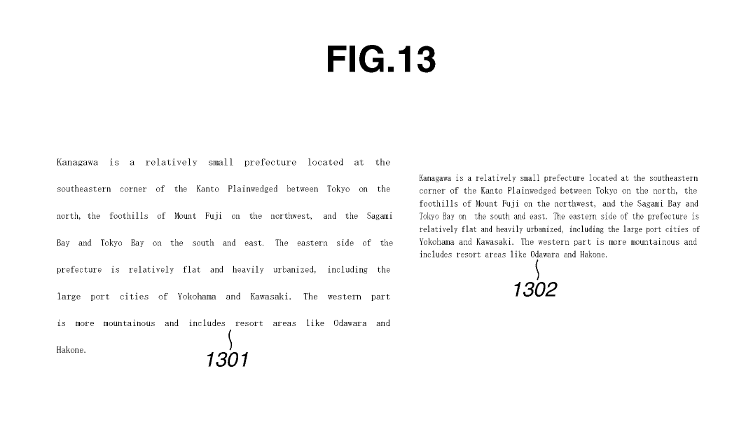

FIG. 13 illustrates a specific example of the text processed by the method illustrated in FIG. 12. Referring to FIG. 13, the number of reference values for the non-acceptable layout evaluation values is 4.

For an input document 1301, five layout evaluation values including the line spacing, the text region width, the character size, the character spacing, and the inner-line layout balance are non-acceptable. Accordingly, the layout variable value changing unit 1103 outputs a document 1302, whose all layout evaluation values are acceptable.

On the other hand, if it is determined that the number of the non-acceptable layout evaluation values is equal to or less than the predetermined number (i.e., if a small number of layout evaluation values are non-acceptable) (YES in operation S1201), then the following processing is executed.

In this case, the change may be more efficiently executed by changing the small number of non-acceptable layout variable values only instead of changing all the layout variable values by using the layout variable value changing unit 1103. Accordingly, in this case, in operation S1203, a common layout variable value changing unit 1104 is used. In the present exemplary embodiment, a layout variable used for acquiring a plurality of layout evaluation items is referred to as a “common layout variable”.

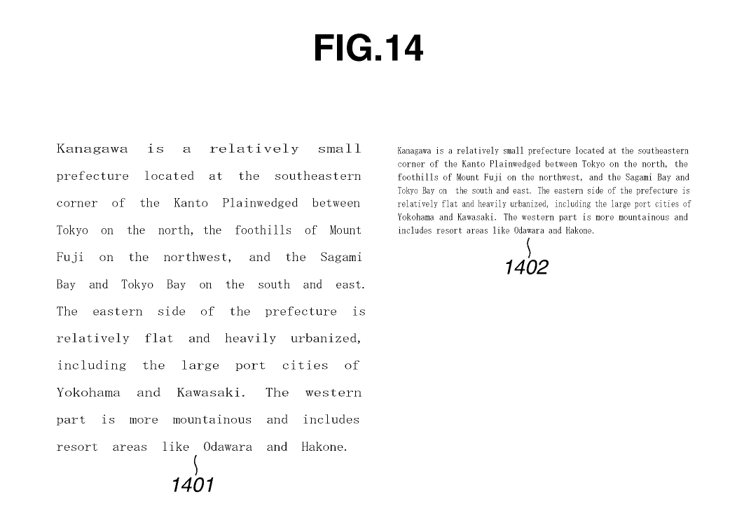

FIG. 14 illustrates a specific example of the text processed by the above-described method. Referring to FIG. 14, for an input document 1401, three layout evaluation values including the line spacing, the character size, and the inner-line layout balance are non-acceptable.

The term “character size” is included in all the three calculation expressions. Accordingly, the common layout variable value changing unit 1104 changes the character size only. As a result, a document 1402, whose all layout evaluation values are acceptable, is output.

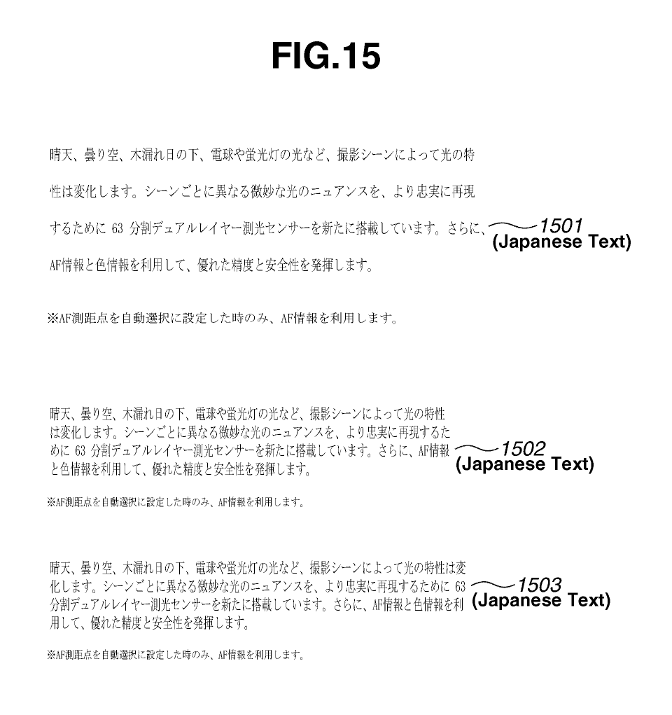

The change may be more efficiently executed by changing the small number of non-acceptable layout variable values only instead of changing all the layout variable values because of the following reasons described with reference to FIG. 15.

For an input text 1501, the note character size and the line spacing do not satisfy the reference value. The calculation expressions for the two layout evaluation values commonly include the character size (the note character size 801 and the line spacing 803).

In the example illustrated in FIG. 15, an output text 1502 is a result of optimization executed by using the layout variable value changing unit 1103. On the other hand, an output document 1503 is a result of optimization executed by using the common layout variable value changing unit 1104 by changing the character size only.

Both units may improve the line spacing to be acceptable. More specifically, if the layout variable value changing unit 1103 is used, it becomes necessary to adjust three values including the character size, the text region width, and the number of lines. On the other hand, if the common layout variable value changing unit 1104 is used, the character size only may be adjusted. Accordingly, the latter method, by which it is necessary to adjust only one item, is more efficient.

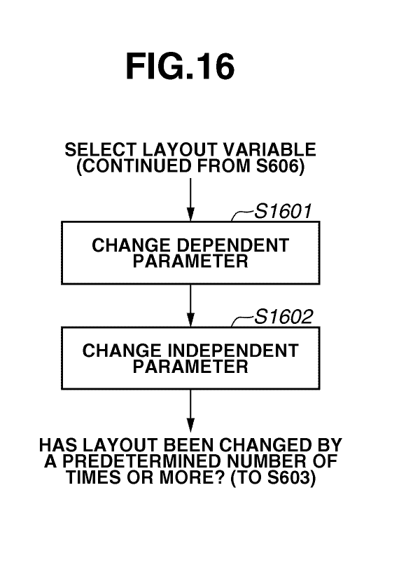

After determining the layout variable to be used in operation S606, the layout parameter is changed in operation S607. operation S607 includes two sub steps. Referring to FIG. 16, in operation S1601, a dependent parameter is changed. In operation S1602, an independent parameter is changed.

In the present exemplary embodiment, the parameter includes components constituting the text layout including the layout variable. More specifically, the parameter includes the character size, the text region width, the number of lines, the note character size, the word spacing, the line spacing, the Japanese character-to-alphabetic character interval, the character spacing, the inner-line layout balance, the itemized list appearance, and the same-word appearance interval. The above-described parameters will hereafter be collectively referred to as a “layout parameter (s)”. The layout evaluation item is included in the layout parameter and is used in evaluating a layout.

In operation S1601, the layout variables of the parameters having a cross-dependent relationship (i.e., if one parameter is changed and any other parameter is influenced, the layout variables of the parameter and the other parameter), such as the character size, the text region width, and the number of lines, are changed. Accordingly, the parameters should be changed in appropriate order.

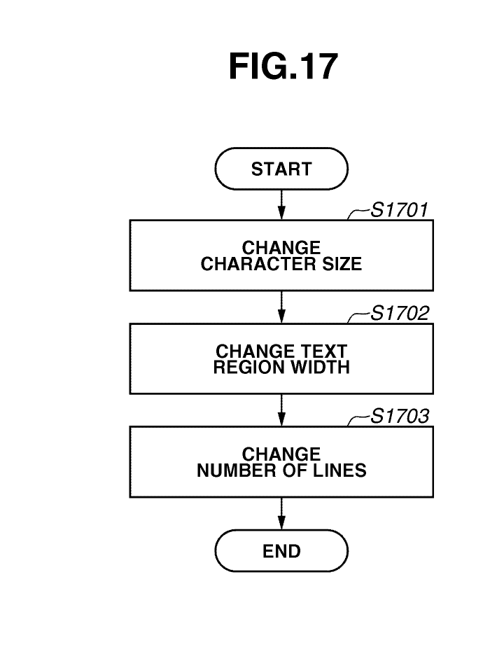

A common layout variable is one of the cross-dependent parameters. FIG. 17 illustrates in detail an example of the common layout variable.

Referring to FIG. 17, the change is executed in order of operation S1701, operation S1702, and operation S1703. In operation S1701, the character size is changed. In operation S1702, the text region width is changed. In operation S1703, the number of lines is changed. The change is executed because of the following reason.

Any change in the character size may influence the text region width. Furthermore, any change in the text region width may influence the number of lines. However, no other influence is given. Accordingly, if any other variable is changed after the variable is improved, no adverse influence is given in this case. This is the reason why the change described above is executed.

More specifically, in executing the change, for the character size and the text region width, the value is changed to the optimum value in the first changing operation. In the second changing operation and beyond, the character size and the text region width are changed at random within the permissible range. The number of lines is changed according to the character size and the text region width determined in steps S1701 and S1702 and according to the number of characters of the input text.

The optimum value and the permissible range for each parameter are determined in calculating the layout evaluation value in operation S604. The dependent parameters are the same as the layout variable as described above. Accordingly, the parameters that are the same as the layout variable determined not to be used in operation S606 are not changed. In other words, a operation for changing the value of the variable is skipped.

In operation S1602, independent parameters, which are not mutually influenced, are changed. In operation S1602, the parameters, such as the note character size, the word spacing, the line spacing, the Japanese character-to-alphabetic character interval, the character spacing, the inner-line layout balance, the itemized list appearance, and the same-word appearance interval. The above-described parameters do not influence one another. Accordingly, the order of processing may be arbitrarily determined.

The values of the parameters are calculated by using the layout evaluation value calculation expressions (1), (2), (3), (4), and (7). For each calculation expression, values of the character size, the text region width, and the number of lines determined in operation S1601 are used.

The present exemplary embodiment is implemented by the above-described configuration and method. It is not necessary that all the layout evaluation items and all the layout variable values described above are used. In other words, the user may select any one to be used as desired.

With the above-described configuration, the present exemplary embodiment may generate a text whose legibility is high by simply changing a plurality of layout evaluation values related to the text without adversely influencing one another while reducing the load of a calculation operation executed in changing the layout of the text. In addition, the present exemplary embodiment having the above-described configuration may efficiently adjust the text layout by selecting the method for adjusting the layout variable value according to the situation.

Now, a second exemplary embodiment will be described in detail below.

In the above-described first exemplary embodiment, the layout evaluation values are calculated and the layout variable values are changed to change all the layout evaluation values to satisfy the reference value. However, the efficiency may not be high if the layout variable values are merely changed.

In the present exemplary embodiment, the layout variable value adjustment unit 505 executes the processing by various methods. In other words, the processing method is changed according to the situation.

In the first exemplary embodiment, the unit to be used may be changed between the layout variable value changing unit 1103 and the common layout variable value changing unit 1104. In the present exemplary embodiment, a layout evaluation value coefficient changing unit 1105 is used in addition to the layout variable value changing unit 1103 and the common layout variable value changing unit 1104. This configuration is employed to improve each layout evaluation value to be acceptable by slightly changing the evaluation reference value by changing the coefficient included in the calculation expression for calculating the layout evaluation value within the permissible range.

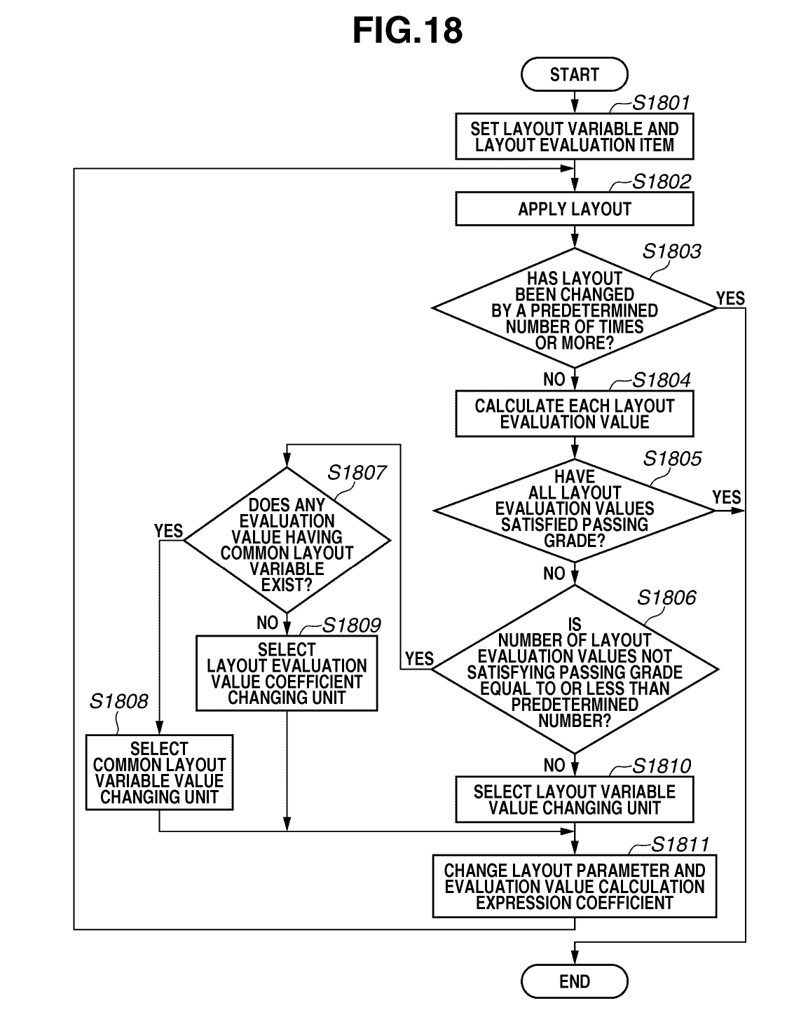

FIG. 18 is a flow chart illustrating an exemplary flow of processing executed by additionally using the layout evaluation value coefficient changing unit 1105 according to the present exemplary embodiment.

Referring to FIG. 18, processing in steps S1801 through S1805 is similar to the processing in steps S601 through S605. Processing in operation S1806 is similar to the processing in operation S1201.

Processing in operation S1810, which is executed if the number of non-acceptable layout evaluation values is more than a predetermined number (NO in operation S1806), is similar to the processing in operation S1202. In addition, processing in operation S1808 is similar to the processing in operation S1203.

The present exemplary embodiment is different from the first exemplary embodiment in the following point. In other words, the present exemplary embodiment executes the following processing if it is determined in operation S1806 that the number of non-acceptable layout evaluation values is equal to or less than the predetermined number (YES in operation S1806).

In this case, in operation S1807, it is determined whether a common layout variable is included in the calculation expression for calculating the non-acceptable layout evaluation value. If it is determined that no layout evaluation value with a common layout variable exists (NO in operation S1807), it is determined that the processing may be more efficiently executed by changing the reference value of an individual layout evaluation value within the permissible range. In operation S1809, the layout evaluation value coefficient changing unit 1105 executes the processing.

More specifically, the layout evaluation value coefficient changing unit 1105 changes the coefficient in each layout evaluation value calculation expression individually within the permissible range and slightly changes the evaluation reference value to improve the layout evaluation value to be acceptable.

If the variable and the coefficient are to be changed as the first operation of the processing, the predetermined optimum value of each of the variable and the coefficient is used. In the steps after the first operation of the processing, the variable and the coefficient are changed at random.

On the other hand, if a common layout variable value exists, it is determined that the processing may be more efficiently executed by changing the common layout variable value. In operation S1808, the common layout variable value changing unit 1104 executes the processing similar to the processing in operation S1203 as described above.

In operation S1811, the processing unit determined by the above-described processing changes the layout parameter or the layout evaluation value calculation expression coefficient.

With the above-described configuration, the present exemplary embodiment optimizes the text layout by using the above-described processing units. Similar to the first exemplary embodiment, it is not necessary that all the layout evaluation items and all the layout variable values described above are used. In other words, the user may select any one to be used as desired.

With the above-described configuration, the present exemplary embodiment may more efficiently adjust the text layout by executing the method for changing the coefficient of the layout evaluation value calculation expression that is appropriate according to the situation as the method for adjusting the layout variable value.

Now, a third exemplary embodiment will be described in detail below. In the present exemplary embodiment, the example described above in the second exemplary embodiment is implemented as a computer program.

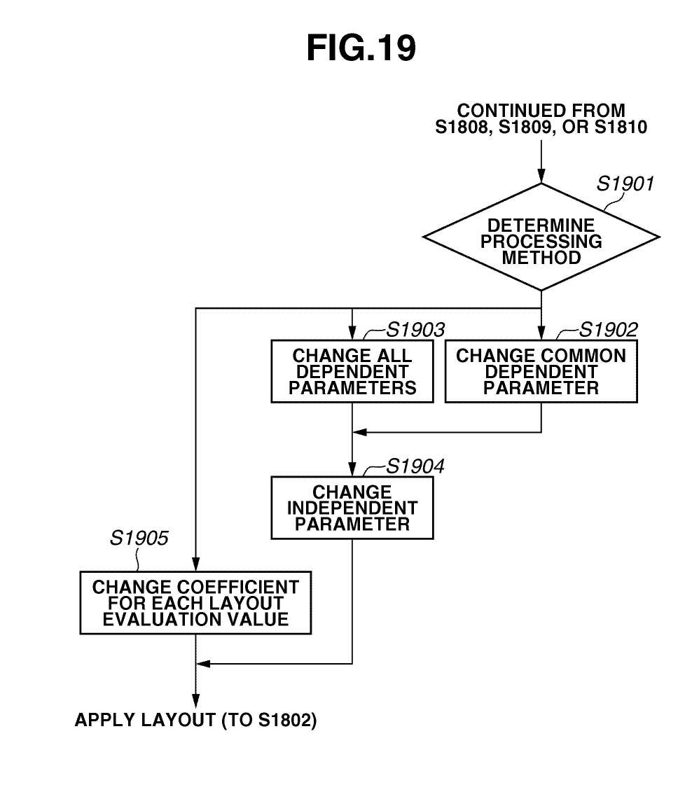

The outline of the flow of the processing according to the present exemplary embodiment is as described above with reference to FIG. 18. Accordingly, in the following description, processing in operation S1811 will be described in detail below with reference to FIG. 19.

Referring to FIG. 19, in operation S1901, the processing method selected in operation S1808, S1809, or 1810 is loaded. The next processing operation is determined according to the processing method. If it is determined that the common layout variable value changing unit 1104 is to be used, the processing advances to operation S1902. In operation S1902, the common dependent parameter (the layout variable) is changed. In operation S1904, the independent parameter is changed.

On the other hand, if the layout variable value changing unit 1103 has been selected, the processing advances to operation S1903. In operation S1903, all the dependent parameters (all the layout variables) are changed. In operation S1904, the independent parameter is changed. Furthermore, if the layout evaluation value coefficient changing unit 1105 has been selected, the processing advances to operation S1905. In operation S1905, the coefficient included in the non-acceptable layout evaluation value calculation expression is changed.

In this case, because the layout parameter is not changed, the text layout itself is not changed. After the above-described processing is completed, the processing returns to operation S1802. In operation S1802 and beyond, the document editing apparatus serially executes processing for executing the layout, determining the number of times of changes, calculating each layout evaluation value, and determining whether the layout evaluation value satisfies the reference value.

The present exemplary embodiment optimizes the text layout in the above-described manner. Similar to the first and the second exemplary embodiments described above, it is not necessary that all the layout evaluation items and all the layout variable values described above are used. In other words, the user may select any one to be used as desired.

With the above-described configuration, the present exemplary embodiment may efficiently adjust the text layout on a computer.

As another exemplary embodiment, the following may be employed.

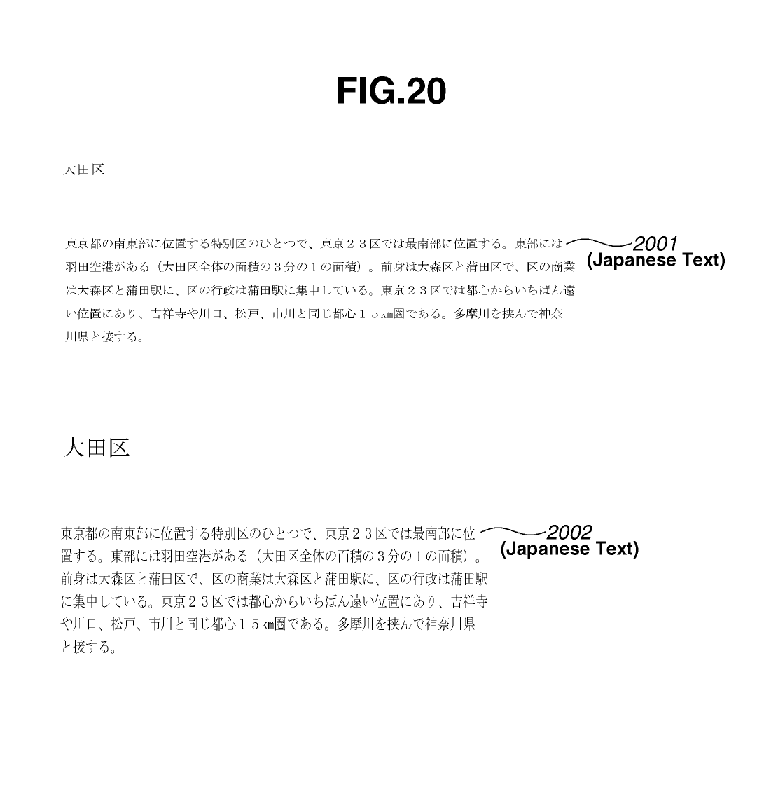

If all the layout evaluation values do not become acceptable after changing for the predetermined number of times, the present exemplary embodiment employs the value with which most layout evaluation values have become acceptable up to the current timing. In an example illustrated in FIG. 20, it is supposed that after changing the layout variables for an input text 2001 for a predetermined number of times, the balance among the lines only is not acceptable. In this case, the current state is determined as the most effective and the document editing apparatus outputs a document 2002.

The first exemplary embodiment is directed to the optimization of the layout of an input text but exemplary embodiments may prevent disimprovement of the text by editing the text by hand. For example, when the character size is within the permissible range and when the user is to set a value outside the permissible range by manually editing the text, the user may still set a value within the permissible range or cancel the editing operation itself. With the above-described configuration, exemplary embodiments may prevent an editing that may degrade the legibility of the text and may generate a most appropriate text layout under the given situation.

The embodiments may also be achieved by providing a system or an apparatus with a storage medium storing program code of software implementing the functions of the embodiments and by reading and executing the program code stored in the storage medium with a computer of the system or the apparatus (a central processing unit (CPU) or a micro processing unit (MPU)).

According to an exemplary embodiment, a document with a high legibility may be generated by adjusting the layout variable value.

Further, the present exemplary embodiment may also be realized by supplying software (e.g., a program or a set of instructions) for realizing the functions of the above exemplary embodiments to a system or an apparatus via a network or via various storage media, and having a computer (a central processing unit (CPU) or a micro processing unit (MPU)) of the system or apparatus read and execute the program or the instructions recorded/stored on an article of manufacture having a memory device or a non-transitory storage medium to perform operations or functions of the above-described embodiments. In this case, this program and the recording medium on which the program is recorded/stored constitute one disclosed aspect of the embodiments. In addition, the program may be executed by one computer, or by a plurality of computers linked together.

Disclosed aspects of the embodiments may be realized by an apparatus, a machine, a method, a process, or an article of manufacture that includes a non-transitory storage medium having a program or instructions that, when executed by a machine or a processor, cause the machine or processor to perform operations as described above. The method may be a computerized method to perform the operations with the use of a computer, a machine, a processor, or a programmable device. The operations in the method involve physical objects or entities representing a machine or a particular apparatus (e.g., a document editing apparatus, a document). In addition, the operations in the method transform the elements or parts from one state to another state. The transformation is particularized and focused on document editing. The transformation provides a different function or use such as extracting a layout variable, adjusting a value of the layout variable, displaying the document, etc.

In addition, elements of one embodiment may be implemented by hardware, firmware, software or any combination thereof. The term hardware generally refers to an element having a physical structure such as electronic, electromagnetic, optical, electro-optical, mechanical, electro-mechanical parts, etc. A hardware implementation may include analog or digital circuits, devices, processors, applications specific integrated circuits (ASICs), programmable logic devices (PLDs), field programmable gate arrays (FPGAs), or any optical, electromechanical, electromagnetic, or electronic devices. The term software generally refers to a logical structure, a method, a procedure, a program, a routine, a process, an algorithm, a formula, a function, an expression, etc. A software implementation typically includes realizing the above elements (e.g., logical structure, method, procedure, program) as instruction codes and/or data elements embedded in one or more storage devices and executable and/or accessible by a processor, a CPU/MPU, or a programmable device as discussed above. The term firmware generally refers to a logical structure, a method, a procedure, a program, a routine, a process, an algorithm, a formula, a function, an expression, etc., that is implemented or embodied in a hardware structure (e.g., flash memory). Examples of firmware may include microcode, writable control store, micro-programmed structure. When implemented in software or firmware, the elements of an embodiment may be the code segments to perform the necessary tasks. The software/firmware may include the actual code to carry out the operations described in one embodiment, or code that emulates or simulates the operations.

All or part of an embodiment may be implemented by various means depending on applications according to particular features, functions. These means may include hardware, software, or firmware, or any combination thereof. A hardware, software, or firmware element may have several modules or units coupled to one another. A hardware module/unit is coupled to another module/unit by mechanical, electrical, optical, electromagnetic or any physical connections. A software module/unit is coupled to another module by a function, procedure, method, subprogram, or subroutine call, a jump, a link, a parameter, variable, and argument passing, a function return, etc. A software module/unit is coupled to another module/unit to receive variables, parameters, arguments, pointers, etc. and/or to generate or pass results, updated variables, pointers, etc. A firmware module/unit is coupled to another module/unit by any combination of hardware and software coupling methods above. A hardware, software, or firmware module/unit may be coupled to any one of another hardware, software, or firmware module/unit. A module/unit may also be a software driver or interface to interact with the operating system running on the platform. A module/unit may also be a hardware driver to configure, set up, initialize, send and receive data to and from a hardware device. An apparatus may include any combination of hardware, software, and firmware modules/units.

While the present invention has been described with reference to exemplary embodiments, it is to be understood that the embodiments are not limited to the disclosed exemplary embodiments. The scope of the following claims is to be accorded the broadest interpretation so as to encompass all modifications, equivalent structures, and functions.

This application claims priority from Japanese Patent Application No. 2010-293020 filed Dec. 28, 2010, which is hereby incorporated by reference herein in its entirety.

What is claimed is:

1. A document editing apparatus, comprising:
an extraction unit configured to extract a layout variable used for acquiring an evaluation value for a plurality of layout evaluation items used to evaluate a layout of a document, if any layout evaluation item among the plurality of layout evaluation values exists that does not satisfy a layout evaluation reference value;
an adjustment unit configured to adjust a value of the layout variable to satisfy the layout evaluation reference value; and
a control unit configured to display the document whose layout has been adjusted by the adjustment unit.

2. The document editing apparatus according to claim 1, wherein the adjustment unit includes a selection unit configured to select the layout variable to be adjusted according to a number of layout evaluation items that do not satisfy the layout evaluation reference value.

3. The document editing apparatus according to claim 1, wherein the adjustment unit includes a coefficient changing unit configured to adjust a coefficient used for acquiring the evaluation value for the plurality of layout evaluation items if no layout variable is extracted by the extraction unit.

4. A document editing method, comprising:
extracting a layout variable used for acquiring an evaluation value for a plurality of layout evaluation items used to evaluate a layout of a document, if any layout evaluation item among the plurality of layout evaluation values exists that does not satisfy a layout evaluation reference value;
adjusting a value of the layout variable to satisfy the layout evaluation reference value; and
displaying the document whose layout has been adjusted by adjusting the value of the layout variable.

5. A computer-readable storage medium storing instructions which, when executed by a computer, cause the computer to perform operations comprising:
extracting a layout variable used for acquiring an evaluation value for a plurality of layout evaluation items used to evaluate a layout of a document, if any layout evaluation item among the plurality of layout evaluation values exists that does not satisfy a layout evaluation reference value;
adjusting a value of the layout variable to satisfy the layout evaluation reference value; and
displaying the document whose layout has been adjusted by adjusting the value of the layout variable.
